(19) United States
(12) Patent Application Publication
(10) Pub. No.: US 2017/0000093 A1
(43) Pub. Date: Jan. 5, 2017

(54) FABRIC FOR PREVENTING ADHESION OF AQUATIC ORGANISMS

(71) Applicant: DAIKIN INDUSTRIES, LTD., Osaka-shi, Osaka (JP)

(72) Inventors: Ken YOSHIDA, Settsu-shi, Osaka (JP); Kazuya KAWAHARA, Settsu-shi, Osaka (JP); Masayuki TSUJI, Settsu-shi, Osaka (JP)

(73) Assignee: DAIKIN INDUSTRIES, LTD., Osaka-shi, Osaka (JP)

(21) Appl. No.: 14/900,261

(22) PCT Filed: Jun. 20, 2014
(86) PCT No.: PCT/JP2014/066470

§ 371 Date: Dec. 21, 2015

(30) Foreign Application Priority Data
Jun. 24, 2013 (JP) 2013-131934

(51) Int. Cl. A01K 75/00; D03D 15/00

(52) U.S. Cl. CPC A01K 75/00; D03D 15/00

(57) ABSTRACT

The present invention aims to provide a fabric for preventing adhesion of aquatic organisms which is excellent in an effect of preventing adhesion of aquatic organisms and in strength, which readily sinks in water, and which is suitable for use in various forms and environments. The fabric for preventing adhesion of aquatic organisms of the present invention includes yarn containing a fluororesin.

### TECHNICAL FIELD

The present invention relates to a fabric for preventing adhesion of aquatic organisms.

### BACKGROUND ART

Many aquatic organisms (marine organisms), such as Balanomorpha, Ascidiacea, Serpula, Mytilus galloprovincialis, Cristaria plicata, Bugulidae, Enteromorpha, and Ulva, adhere to and grow on the surfaces of a variety of underwater structures, such as seawater-intake facilities of power plants, buildings (including ships), and articles to be used on water or underwater typified by fishing tools (e.g., fishing nets), and they seem to cause problems such as functional degradation or malfunction of underwater structures. Such adhering aquatic organisms have generally been removed by mechanical methods, such as scraping away at regular intervals. Currently, in contrast, various anti-fouling paints are developed and adhesion of aquatic organisms is mainly prevented by applying such coatings to the surfaces of underwater structures.

Examples of such anti-fouling paints include those containing toxic anti-fouling agents, such as organotin compounds, cuprous oxide, zinc pyrithione, and copper pyrithione. These anti-fouling paints can actually prevent adhesion and growth of aquatic organisms; however, since they contain toxic anti-fouling agents, such paints are preferably not produced or applied in terms of environment, health and safety. In addition, the toxic anti-fouling agents flow out from the paint films in water, and thus may pollute the water area over the long term.

Patent Literature 1 discloses a method of preventing adhesion of aquatic organisms to an underwater structure comprising covering the whole water draft portion of an underwater structure with a specific polyolefin sheet.

Patent Literature 2 discloses a method of preventing adhesion of underwater organisms to the surface of an underwater structure comprising covering the surface of an underwater structure with a specific fabric, net, or porous sheet.

Patent Literature 3 discloses a composite marine structure comprising a marine substrate having adhered to at least a portion of its surface a layer of a water-permeable composite article comprising a non-woven fibrous web having entrapped therein active particulate to provide the marine structure with protection against at least one of fouling and corrosion.

### CITATION LIST

### Patent Literature

Patent Literature 1: JP 2000-287602 A

Patent Literature 2: JP S63-22908 A

Patent Literature 3: JP H08-505337 T

### SUMMARY OF INVENTION

### Technical Problem

The present invention is devised in consideration of the above situation, and aims to provide a fabric for preventing adhesion of aquatic organisms which is excellent in an effect of preventing adhesion of aquatic organisms and in strength, which readily sinks in water, and which is suitable for use in various forms and environments.

### Solution to Problem

The present inventors have found that a fabric formed from yarn containing a fluororesin have a better effect of preventing adhesion of aquatic organisms than fabric formed from any commodity resin such as polyamide, polyester, or polyvinyl chloride. They have also found that the above fabric has better strength and is more suitable for use in various forms and environments than nonwoven fabric. They have additionally found that the above fabric more readily sinks in water because the fluororesin has a higher specific gravity than commodity resin such as polyamide, polyester, and polyvinyl chloride. Thereby, the inventors have completed the present invention.

Specifically, the present invention relates to a fabric for preventing adhesion of aquatic organisms, comprising yarn containing a fluororesin.

The fluororesin preferably comprises at least one selected from the group consisting of polytetrafluoroethylene (PTFE), tetrafluoroethylene (TFE)/perfluoro(alkyl vinyl ether) (PAVE) copolymers (PFA), TFE/hexafluoropropylene (HFP) copolymers (FEP), ethylene (Et)/TFE copolymers (ETFE), Et/TFE/HFP copolymers, polychlorotrifluoroethylene (PCTFE), chlorotrifluoroethylene (CTFE)/TFE copolymers, Et/CTFE copolymers, and polyvinylidene fluoride (PVDF), and more preferably polytetrafluoroethylene (PTFE).

The present invention also relates to a net comprising the above fabric for preventing adhesion of aquatic organisms.

The present invention also relates to a fishing net comprising the above fabric for preventing adhesion of aquatic organisms.

### Advantageous Effects of Invention

Since the fabric for preventing adhesion of aquatic organisms of the present invention comprises yarn containing a fluororesin, it is excellent in an effect of preventing adhesion of aquatic organisms and in strength, readily sinks in water, and is suitable for use in various forms and environments.

### BRIEF DESCRIPTION OF THE DRAWINGS

FIG. 1 is a picture of the appearance of a fabric in Example 2.

FIG. 2 is a picture of the appearance of a nonwoven fabric in Comparative Example 3.

### DESCRIPTION OF EMBODIMENTS

The present invention will be described in detail below.

The fabric for preventing adhesion of aquatic organisms of the present invention (hereinafter, also simply referred to as the fabric of the present invention) comprises yarn containing a fluororesin. Thus, it can exert an excellent effect of preventing adhesion of aquatic organisms.

Examples of the aquatic organisms include Balanomorpha, Mytilus galloprovincialis, Actiniaria, Ostreidae, Ascidiacea, Hydrozoa, Bryozoa, various aquatic microorganisms, various marine algae (e.g., Siphonocladales, Sargassaceae, Ulva, Enteromorpha), various Diatomea, Annelida (e.g., Dexiospira foraminosa, Filograna implexa), and Porifera (e.g., Tethya aurantium).

The term “fluororesin” herein means a partially crystalline fluoropolymer and fluoroplastic. The fluororesin has a melting point and is thermoplastic. It may be melt-processible or may be non-melt-processible.

The term “melt-processible” herein means that a polymer can be melt-processed using a conventional processing device such as an extruder or an injection-molding device. Thus, the melt-processible fluororesin usually has a melt flow rate of 0.01 to 100 g/10 min, which is measured by the following method.

The fluororesin usually has a specific gravity of 1.75 to 2.20, which is higher than that of commodity resin, such as polyamides (e.g., nylon) (specific gravity: 1.13 to 1.15), polyester (specific gravity: 1.30 to 1.38), and vinyl chloride (specific gravity: 1.35 to 1.45). Thereby, the fabric of the present invention readily sinks in water.

The specific gravity of the fluororesin in the present invention is preferably 1.75 or higher, and more preferably as high as possible.

The specific gravity of the fluororesin in the present invention can be determined by the immersion method.

The fluororesin in the present invention has a melting point of preferably 100° C. to 360° C., more preferably 140° C. to 360° C., still more preferably 160° C. to 360° C., particularly preferably 180° C. to 360° C.

The melting point of the fluororesin herein is a temperature corresponding to the maximum value on the heat-of-fusion curve drawn at a temperature-increasing rate of 10° C./min using a differential scanning calorimeter (DSC).

Examples of the fluororesin include polytetrafluoroethylene (PTFE), tetrafluoroethylene (TFE)/perfluoro(alkyl vinyl ether) (PAVE) copolymers (PFA), TFE/hexafluoropropylene (HFP) copolymers (FEP), ethylene (Et)/TFE copolymers (ETFE), Et/TFE/HFP copolymers, polychlorotrifluoroethylene (PCTFE), chlorotrifluoroethylene (CTFE)/TFE copolymers, Et/CTFE copolymers, polyvinylidene fluoride (PVDF), and polyvinyl fluoride (PVF). In order to exert a better effect of preventing adhesion of aquatic organisms, the fluororesin preferably comprises at least one selected from the group consisting of PTFE, PFA, FEP, ETFE, Et/TFE/HFP copolymers, PCTFE, CTFE/TFE copolymers, Et/CTFE copolymers, and PVDF, more preferably at least one selected from the group consisting of PTFE, PFA, FEP, and ETFE, still more preferably PTFE.

The PTFE may be a homo PTFE consisting only of a TFE unit or may be a modified PTFE consisting of a TFE unit and a modifying monomer unit derived from a modifying monomer copolymerizable with TFE. The PTFE may be a high molecular weight PTFE which is non-melt-processible and fibrillatable, or may be a low molecular weight PTFE which is melt-processible and non-fibrillatable.

The modifying monomer may be any monomer copolymerizable with TFE. Examples thereof include perfluoroolefins such as hexafluoropropylene (HFP); chlorofluoroolefins such as chlorotrifluoroethylene (CTFE); hydrogen-containing fluoroolefins such as trifluoroethylene and vinylidene fluoride (VDF); perfluorovinyl ethers; perfluoroalkyl ethylenes; ethylene; and fluorine-containing vinyl ethers having a nitryl group. One modifying monomer may be used or multiple modifying monomers may be used.

Any perfluorovinyl ethers may be used, and examples thereof include an unsaturated perfluoro compound represented by the following formula (1):

CF₂═CF—ORf¹ (1)

wherein Rf¹ represents a perfluoroorganic group. The term “perfluoroorganic group” herein means an organic group in which all the hydrogen atoms bonded to carbon atoms are replaced by fluorine atoms. The perfluoroorganic group may have etheric oxygen.

Examples of the perfluorovinyl ethers include perfluoro(alkyl vinyl ethers) (PAVE) represented by the above formula (1) wherein Rf¹ is a C1-C10 perfluoroalkyl group. The perfluoroalkyl group preferably has 1 to 5 carbon atoms.

Examples of the perfluoroalkyl group in PAVE include a perfluoromethyl group, a perfluoroethyl group, a perfluoropropyl group, a perfluorobutyl group, perfluoropentyl group, and a perfluorohexyl group. Preferred is perfluoropropyl vinyl ether (PPVE) in which the perfluoroalkyl group is a perfluoropropyl group.

Examples of the perfluorovinyl ethers further include those represented by the formula (1) wherein Rf¹ is a C4-C9 perfluoro(alkoxy alkyl) group, those represented by the formula (1) wherein Rf¹ is a group represented by the formula:

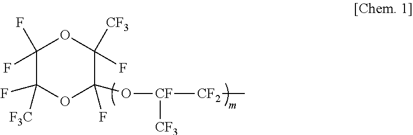

wherein m represents 0 or an integer of 1 to 4, and those represented by the formula (1) wherein Rf¹ is a group represented by the formula:

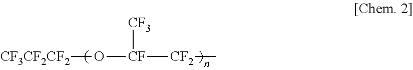

wherein n represents an integer of 1 to 4.

Any perfluoroalkyl ethylenes may be used, and examples thereof include perfluorobutyl ethylene (PFBE) and perfluorohexyl ethylene.

For the fluorine-containing vinyl ethers having a nitryl group, a fluorine-containing vinyl ether represented by CF₂═CFORf²CN (wherein Rf² represents a C2-C7 alkylene group in which an oxygen atom may optionally exist between two carbon atoms) is more preferred.

The modifying monomer in the modified PTFE is preferably at least one selected from the group consisting of HFP, CTFE, VDF, PPVE, PFBE, and ethylene. It is more preferably at least one monomer selected from the group consisting of HFP and CTFE.

The modified PTFE preferably contains 0.001 to 2 mol %, more preferably 0.001 to 1 mol %, of the modifying monomer unit.

The PTFE has a melt viscosity (MV) of preferably 1.0×10 Pa·s or higher, more preferably 1.0×10² Pa·s or higher, and still more preferably 1.0×10³ Pa·s or higher.

The melt viscosity can be determined in conformity with ASTM D 1238 using a flowtester (Shimadzu Corp.) and a 2φ-8L die as follows: 2 g of a sample is pre-heated at a measurement temperature (380° C.) for five minutes, and the sample is maintained at this temperature under a load of 0.7 MPa.

The PTFE preferably has a standard specific gravity (SSG) of 2.130 to 2.230, more preferably 2.140 or higher but 2.190 or lower.

The standard specific gravity (SSG) can be determined by the immersion method in conformity with ASTM D 4895-89.

The PTFE preferably has a melting point of 324° C. to 360° C.

The PTFE preferably has a specific gravity of 2.130 to 2.230, more preferably 2.140 or higher.

The PFA is not particularly limited, and it is preferably a copolymer of a TFE unit and a PAVE unit at a ratio by mole (TFE unit/PAVE unit) of not lower than 70/30 but lower than 99/1. The ratio by mole is more preferably 70/30 or higher and 98.9/1.1 or lower, still more preferably 80/20 or higher and 98.5/1.5 or lower. If the proportion of the TFE unit is too low, the mechanical properties tend to deteriorate. If the proportion thereof is too high, the melting point tends to be so high that the moldability may deteriorate. The PFA is also preferably a copolymer including 0.1 to 10 mol % of a monomer unit derived from a monomer copolymerizable with TFE and PAVE and 90 to 99.9 mol % in total of the TFE unit and the PAVE unit. Examples of the monomer copolymerizable with TFE and PAVE include HFP, vinyl monomers represented by the formula: CZ³Z⁴═CZ⁵(CF₂)ₙZ⁶ (wherein Z³, Z⁴, and Z⁵ may be the same as or different from each other, and individually represent a hydrogen atom or a fluorine atom, Z⁶ represents a hydrogen atom, a fluorine atom, or a chlorine atom, and n represents an integer of 2 to 10), and alkyl perfluorovinyl ether derivatives represented by the formula: CF₂═CF—OCH₂—Rf⁷ (wherein Rf⁷ represents a C1-C5 perfluoroalkyl group).

The PFA preferably has a melting point of 180° C. to 340° C., more preferably 230° C. to 330° C., still more preferably 280° C. to 320° C.

The PFA preferably has a MFR of 0.1 to 100 g/10 min, more preferably 0.5 to 90 g/10 min, still more preferably 1.0 to 85 g/10 min.

The “MFR” herein means a value determined in conformity with ASTM D 1238 at a temperature of 372° C. and a load of 5 kg.

The PFA preferably has a specific gravity of 2.12 to 2.18.

The FEP is not particularly limited, and it is preferably a copolymer including a TFE unit and a HFP unit at a ratio by mole (TFE unit/HFP unit) of not lower than 70/30 but lower than 99/1. The ratio by mole is more preferably 70/30 or higher and 98.9/1.1 or lower, still more preferably 80/20 or higher and 97/3 or lower. If the proportion of the TFE unit is too low, the mechanical properties tend to deteriorate. If the proportion thereof is too high, the melting point tends to be so high that the moldability may deteriorate. The FEP may also preferably be a copolymer including 0.1 to 10 mol % of a monomer unit derived from a monomer copolymerizable with TFE and HFP and 90 to 99.9 mol % in total of the TFE unit and the HFP unit. Examples of the monomer copolymerizable with TFE and HFP include PAVE and alkyl perfluorovinyl ether derivatives.

The FEP preferably has a melting point of 150° C. to 320° C., more preferably 200° C. to 300° C., still more preferably 240° C. to 280° C.

The FEP preferably has a MFR of 0.01 to 100 g/10 min, more preferably 0.1 to 80 g/10 min, still more preferably 1 to 60 g/10 min, particularly preferably 1 to 50 g/10 min.

The FEP preferably has a specific gravity of 2.12 to 2.18.

The ETFE is preferably a copolymer including a TFE unit and an ethylene unit at a ratio by mole (TFE unit/ethylene unit) of 20/80 or higher and 90/10 or lower. The ratio by mole is more preferably 37/63 or higher and 85/15 or lower, still more preferably 38/62 or higher and 80/20 or lower. The ETFE may also be a copolymer including TFE, ethylene, and a monomer copolymerizable with TFE and ethylene. Examples of the copolymerizable monomer include monomers represented by any of the following formulas:

CH₂═CX⁵Rf³,CF₂═CFRf³,CF₂═CFORf³,CH₂═C(Rf³)₂

(wherein X⁵ represents a hydrogen atom or a fluorine atom, and Rf³ represents a fluoroalkyl group which may optionally has an ether bond). Preferred are fluorovinyl monomers represented by any of the formulas: CF₂═CFRf³, CF₂═CFORf³, and CH₂═CX⁵Rf³. More preferred are HFP, perfluoro(alkyl vinyl ethers) represented by the formula: CF₂═CF—ORf⁴ (wherein Rf⁴ is a C1-C5 perfluoroalkyl group), and fluorovinyl monomers represented by the formula: CH₂═CX⁵Rf³ (wherein Rf³ is a C1-C8 fluoroalkyl group). The monomer copolymerizable with TFE and ethylene may also be an aliphatic unsaturated carboxylic acid such as itaconic acid or itaconic anhydride. The proportion of the monomer copolymerizable with TFE and ethylene is preferably 0.1 to 10 mol %, more preferably 0.1 to 5 mol %, particularly preferably 0.2 to 4 mol %, relative to the fluoropolymer.

The ETFE preferably has a melting point of 140° C. to 340° C., more preferably 160° C. to 300° C., still more preferably 195° C. to 275° C.

The ETFE preferably has a MFR of 1 to 100 g/10 min, more preferably 2 to 50 g/10 min, still more preferably 4 to 40 g/10 min.

The ETFE preferably has a specific gravity of 1.70 to 1.90.

The amounts of the respective monomer units constituting the fluororesin in the present description can be determined by any appropriate combination of NMR, FT-IR, elemental analysis, and X-ray fluorescence analysis in accordance with the type of the target monomer.

The yarn constituting the fabric of the present invention may be any one containing a fluororesin. It may be prepared by processing a fluororesin into the form of yarn, or by partially or completely covering the surface of fluororesin-free yarn with a fluororesin.

Examples of a material constituting the fluororesin-free yarn include fluorine-free thermoplastic or thermosetting resin.

Preferred is thermoplastic resin. Thermoplastic resin is a resin which deforms or flows due to external force when heated.

Examples of the thermoplastic resin include polyamide resin, polyethylene resin, polypropylene resin, polyvinylidene fluoride resin, acrylic resin, polyacrylonitrile, acrylonitrile-butadiene-styrene (ABS) resin, polystyrene resin, acrylonitrile-styrene (AS) resin, vinyl chloride resin, polyethylene terephthalate, polyacetal resin, polycarbonate resin, modified polyphenylene ether resin, polyphenylene sulfide resin, polyamide imide resin, polyether imide resin, polysulfone resin, polyether sulfone resin, and mixtures or copolymers thereof.

Preferred is polyamide resin.

The yarn constituting the fabric of the present invention may further contain any additive, if necessary. The additive is not particularly limited, and examples thereof include leveling agents, solid lubricants, pigments, lustering agents, filler, pigment dispersants, surface conditioners, viscosity modifiers, ultraviolet absorbers, light stabilizers, plasticizers, anti-flooding agents, scratch resistance agents, animal repellents, fungicides, antibiotics, anti-corrosion agents, antistatic agents, and silane-coupling agents.

The yarn constituting the fabric of the present invention preferably has an average diameter of 10 to 2000 μm, more preferably 50 to 1000 μm.

The average diameter can be determined using a video microscope.

The yarn constituting the fabric of the present invention preferably has a fineness of 70 to 7000 D. The fineness is more preferably 150 to 3000 D.

The fineness can be calculated from the measured weight (W) and length (L) by the following formula.

Fineness (D)=9000×W (g)/L (m)

The fabric of the present invention may further contain fluororesin-free yarn.

The “fabric” in the present invention means an article formed by interlacing the warp and the weft according to a certain rule.

The fabric allows more water to pass therethrough than sheets. Thus, it is less likely to be broken when used in water and is more easily collected from the water.

Further, the fabric is more flexible than sheets, and thus it can be used in more various forms. Furthermore, the fabric is stronger than nonwoven fabric, and thus it can be used in applications requiring a higher strength.

For the fabric of the present invention, at least one of the warp and the weft has only to be fluororesin-containing yarn.

The fabric of the present invention can be produced by a method including the steps of producing fluororesin-containing yarn and weaving the resulting yarn into fabric, for example.

Methods of producing fluororesin-containing yarn are roughly classified into methods of processing a fluororesin into a yarn-like form and methods of covering the surface of fluororesin-free yarn with a fluororesin.

Different methods of processing a fluororesin into a yarn-like form are applied to PTFE and other fluororesins than PTFE.

If the fluororesin is PTFE, a method of twisting PTFE fibers into a yarn-like form may be applied, for example.

The PTFE fibers can be produced by tearing a PTFE film using a shearing device or emulsion spinning, for example.

The emulsion spinning is performed as follows. A small amount of a polymer to be a matrix is added to a PTFE aqueous dispersion, and the polymer-containing dispersion is spun into a coagulation bath. Thereby, fibers are formed in the state that PTFE particles are dispersed in a matrix. These fibers are then heated up to 330° C. to 400° C., and thereby the matrix is decomposed and evaporated off. At the same time, the PTFE particles are fused with each other to form PTFE fibers. The PTFE fibers are further stretched at a temperature of 300° C. to 400° C., and thereby fibers with improved strength and elongation can be obtained.

The matrix may be formed of a water-soluble polymer such as viscose, sodium alginate, or polyvinyl alcohol.

The method of twisting PTFE fibers may be any known method.

If the fluororesin is a fluororesin other than PTFE, a method such as melt spinning, solution spinning, liquid crystal spinning, flash spinning, electrospinning, flame stretching, a rotary process, melt blowing, spun bonding, or wet spun bonding may be applied, for example.

Examples of the method of covering the surface of fluororesin-free yarn with a fluororesin include a method in which fluororesin-free yarn is immersed in an aqueous dispersion of a fluororesin and then dried. Further, in order to improve the water repellency, a surfactant derived from the aqueous dispersion of a fluororesin may be removed by heating.

The fluororesin-free yarn can be produced by a known method.

The yarn produced as mentioned above may be woven by any known method. The weaving pattern (textile weave) is not particularly limited, and any known weaving pattern, such as plain, twill, or satin, may be applied.

The fabric of the present invention can also be produced by a method including the steps of producing a fabric from fluororesin-free yarn and covering the surface of the resulting fabric with a fluororesin.

The fabric formed from fluororesin-free yarn can be produced by weaving fluororesin-free yarn in a desired weaving pattern by a known method.

Examples of the method of covering the surface of the resulting fabric with a fluororesin include a method in which the fabric is immersed in an aqueous dispersion of a fluororesin and then dried. Further, in order to improve the water repellency, the surfactant derived from the aqueous dispersion of a fluororesin may be removed by heating.

The fabric of the present invention may be bonded to other fabric. This improves the strength of the fabric. Examples of such other fabric include any fluororesin-free fabric, such as non-fluorine fabric formed from yarn of thermoplastic resin, thermosetting resin, or the like. Preferred is fabric formed from yarn of thermoplastic resin, and more preferred is fabric formed from yarn of polyamide resin.

Since the fabric of the present invention comprises yarn containing a fluororesin, it is excellent in an effect of preventing adhesion of aquatic organisms and in strength, readily sinks in water, and is suitable for use in various forms and environments. Thus, the fabric of the present invention can be applied to various underwater structures whether it is used in seawater or in fresh water. The fabric may be used on the surface of water.

The fabric of the present invention can be applied in any form. For example, the fabric of the present invention can be placed on the surfaces of underwater structures. Alternatively, the fabric of the present invention itself can be used as an underwater structure, such as a net.

Non-limiting examples of the underwater structures include the following articles and structures. The “structures” herein means not only fixed buildings such as bridge piers and waterways, but also movable buildings, such as ships, which are mainly used in the state of moving.

Fixed Buildings:

underwater structures such as bridges, concrete blocks, wave-dissipating blocks, breakwaters, and pipelines;

port equipment or facilities such as sluice gates, marine tank containers, and floating docks;

seabed-operation equipment or facilities such as seabed excavation facilities and submarine communications cable equipment;

equipment or facilities for thermal power generation, atomic power generation, tidal power generation, or ocean thermal energy conversion, such as waterways, condensate pipes, water boxes, intakes, and floodgates;

equipment or facilities for water supply and drainage or water storage such as pools, water tanks, water towers, sewerage, and rain gutters; and

household equipment such as built-in appliances, flush toilets, bathrooms, and bathtubs.

Movable Buildings:

draft portions or the bottoms of ships, the exterior of submarines, structures or attachments of ships such as screw propellers, screw propellers, and anchors.

<Articles to be Used on the Surface of Water or Underwater>

Fixed Articles:

fishing tools such as fishing nets (e.g., fixed nets), buoys, fish preserves, and ropes;

articles for thermal power generation, atomic power generation, and ocean thermal energy conversion, such as condensers and water boxes;

articles laid on the seabed (the bottom of the water) such as undersea (underwater) cables; and

a variety of nets.

Movable Articles:

fishing tools such as fishing nets (e.g., trawls) and longlines; and

a variety of nets.

In order to make the best use of fabric, preferred are nets, fishing nets, and ropes.

A net comprising the fabric of the present invention and a fishing net comprising the fabric of the present invention are each one aspect of the present invention.

### EXAMPLES

The present invention will be described below referring to the following non-limiting examples.

### (Melt Viscosity)

The melt viscosity was determined in conformity with

ASTM D 1238 using a flowtester (Shimadzu Corp.) and 2φ-8L die as follows: 2 g of a sample was pre-heated at a measurement temperature (380° C.) for five minutes, and the sample was maintained at this temperature under a load of 0.7 MPa.

### (Standard Specific Gravity (SSG))

The standard specific gravity (SSG) was determined by the immersion method in conformity with ASTM D 4895-89.

### (Melting Point)

The melting point was determined as a temperature corresponding to the maximum value on the heat-of-fusion curve drawn at a temperature-increasing rate of 10° C./min using a differential scanning calorimeter (DSC).

### (Specific Gravity)

The specific gravity was determined by the immersion method.

### (Average Diameter)

The average diameter was determined using a video microscope.

### (Fineness)

The fineness was calculated as the ratio of the mass to the length of the fiber.

### (MFR)

The MFR was determined in conformity with ASTM D 1238 at a temperature of 372° C. and a load of 5 kg.

The amounts of the respective monomer units were determined by any of NMR, FT-IR, elemental analysis, and X-ray fluorescence analysis.

### Example 1

PTFE fabric was formed from yarn (average diameter: 100 μm, fineness: 300 D) of PTFE (SSG: 2.159, melting point: 344° C., specific gravity: 2.159).

The resulting PTFE fabric (test material) was fixed using a test frame made of vinyl chloride. The test material was hung from a quay, and a three-month test for adhesion of aquatic organisms was carried out. The test material was always in seawater. It was pulled up and subjected to a simple analysis after one month and two months from the start of the hanging. The test was finished after three months, and the final observation was performed and the amount of attached aquatic organisms was measured. Table 1 shows the results.

### Comparative Example 1

Nylon fabric was formed from yarn (average diameter: 50 μm, fineness: 35 D) of nylon (specific gravity: 1.13). The resulting nylon fabric was subjected to a three-month test for adhesion of aquatic organisms in the same manner as in Example 1. Table 1 shows the results.

### Comparative Example 2

Polyester fabric was formed from yarn (average diameter: 40 μm, fineness: 50 D) of polyester (specific gravity: 1.31). The resulting polyester fabric was subjected to a three-month test for adhesion of aquatic organisms in the same manner as in Example 1. Table 1 shows the results.

TABLE 1

| | | Comparative | Comparative |
|---|---|---|---|
| | Example 1 | Example 1 | Example 2 |
| | PTFE fabric | Nylon fabric | Polyester fabric |
| Dry weight of | 0.61 | 1.48 | 1.49 |
| adhering organisms | | | |
| after 3 months (g) | | | |

### Example 2

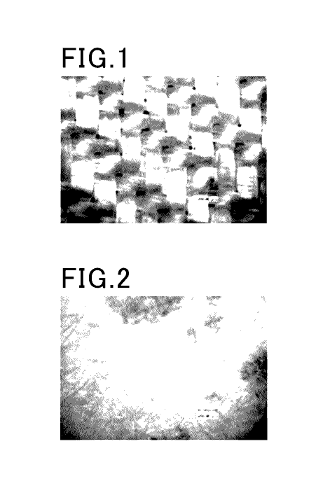

PTFE fabric was formed from yarn (average diameter: 100 μm, fineness: 300 D) of PTFE (SSG: 2.159, melting point: 344° C., specific gravity: 2.159). The resulting PTFE fabric was subjected to a tensile test and measurement of the amount of water permeated. The tensile test was performed in conformity with JIS L1913. For the amount of water permeated, the amount of pure water permeated was measured with a permeation effective cross-sectional area of 13.5 cm² at atmospheric pressure. Table 2 shows the results. FIG. 1 is a picture of the appearance of the PTFE fabric.

### Comparative Example 3

PTFE nonwoven fabric was formed from yarn (average diameter: 100 μm, fineness: 300 D) of PTFE (SSG: 2.159, melting point: 344° C., specific gravity: 2.159). The resulting PTFE nonwoven fabric was subjected to a tensile test and measurement of the amount of water permeated. The tensile test was performed in conformity with JIS L1913. The amount of water permeated was determined in the same manner as in Example 2. Table 2 shows the results. FIG. 2 is a picture of the appearance of the PTFE nonwoven fabric.

### Comparative Example 4

PTFE (SSG: 2.157, melting point: 345° C., specific gravity: 2.157) was compression-molded at 29.4 MPa and sintered for three hours at 370° C. in a sintering furnace. Thereby, a 2.0-mm-thick sheet was produced. The resulting PTFE sheet was subjected to a tensile test and measurement of the amount of water permeated. The tensile test was performed in conformity with JIS K6891. The amount of water permeated was determined in the same manner as in Example 2. Table 2 shows the results.

TABLE 2

| | | Comparative | |
|---|---|---|---|
| | | Example 3 | Comparative |
| | Example 2 | PFTE non- | Example 4 |
| | PTFE fabric | woven fabric | PTFE sheet |
| Tensile strength | 38 | 4 | 57 |
| (MPa) | | | |
| Tensile elongation (%) | 7 | 21 | 450 |
| Amount of water | 12 | 16 | 0 |
| permeated (g/20 sec) | | | |

### Reference Example 1

PTFE (SSG: 2.157, melting point: 345° C., specific gravity: 2.157) was compression-molded at 29.4 MPa and sintered for three hours at 370° C. in a sintering furnace. Thereby, a 2.0-mm-thick sheet was produced. The resulting PTFE sheet was subjected to a test for adhesion of Balanomorpha. Table 3 shows the results.

### Reference Example 2

A FEP sheet was produced in the same manner as in Reference Example 1 except that the PTFE was replaced by a tetrafluoroethylene/hexafluoropropylene copolymer (FEP) (TFE/HFP=93/7 (ratio by mole), melting point: 268° C., specific gravity: 2.12). The resulting FEP sheet was subjected to a test for adhesion of Balanomorpha. Table 3 shows the results.

### (Test for Adhesion of Balanomorpha)

Each of the sheets was hung in a seawater-circulating tank together with a mesh-type test container. Then, larvae in the adhesion period of Balanomorpha were introduced into the test container and the state of adhesion thereof to the sheet was observed. Thereby, for the respective sheets, the effect of preventing adhesion in the stream of water was evaluated.

The number (n) of larvae in the adhesion period of Balanomorpha which were attached to the sheet among those introduced into the test container was counted, and the adhesion rate to the sheet in the stream of water was calculated by the following formula: (n/(number of larvae in the adhesion period of Balanomorpha introduced))×100%.

TABLE 3

| | | Reference | Reference |
|---|---|---|---|
| | | Example 1 | Example 2 |
| Resin | | PTFE | FEP |
| Shape | | Sheet | Sheet |
| Test for | Initial adhesion rate (%) | 11.2 | 59.4 |
| Balanomorpha | Adhesion rate 1 week after | 11.2 | 59.4 |
| adhesion | dropping test (%) | | |
| | Adhesion rate 2 weeks after | 11.2 | 58.5 |
| | dropping test (%) | | |

1. A fabric for preventing adhesion of aquatic organisms, comprising
yarn containing a fluororesin.

2. The fabric for preventing adhesion of aquatic organisms according to claim 1,
wherein the fluororesin comprises at least one selected from the group consisting of polytetrafluoroethylene (PTFE), tetrafluoroethylene (TFE)/perfluoro(alkyl vinyl ether) (PAVE) copolymers (PFA), TFE/hexafluoropropylene (HFP) copolymers (FEP), ethylene (Et)/TFE copolymers (ETFE), Et/TFE/HFP copolymers, polychlorotrifluoroethylene (PCTFE), chlorotrifluoroethylene (CTFE)/TFE copolymers, Et/CTFE copolymers, and polyvinylidene fluoride (PVDF).

3. The fabric for preventing adhesion of aquatic organisms according to claim 1,
wherein the fluororesin is polytetrafluoroethylene (PTFE).

4. A net comprising the fabric for preventing adhesion of aquatic organisms according to claim 1.

5. A fishing net comprising the fabric for preventing adhesion of aquatic organisms according to claim 1.
